(19) United States
(12) Patent Application Publication
(10) Pub. No.: US 2019/0283499 A1
(43) Pub. Date: Sep. 19, 2019

(54) WHEEL FOR VEHICLE

(71) Applicant: CLOVERGLADE LTD., Dublin 2 (IE)

(72) Inventors: Robert George BODILL, Woodstock (GB); Andy BARR, Anahilt (GB); Dana Bryan HOFFER, Media, PA (US)

(21) Appl. No.: 16/337,760

(22) PCT Filed: Sep. 29, 2017
(86) PCT No.: PCT/IB2017/056027

§ 371 Date: Mar. 28, 2019

Related U.S. Application Data
(60) Provisional application No. 62/401,790, filed on Sep. 29, 2016.
(60) Provisional application No. 62/401,798, filed on Sep. 29, 2016.

(51) Int. Cl. B60B 27/02; B62M 1/10; B60B 3/00; B62H 7/00

(52) U.S. Cl. CPC B60B 27/023; B62M 1/10; B62J 2099/0006; B62H 7/00; B60B 2200/47; B60B 3/002

(57) ABSTRACT

A wheel for a human-powered vehicle is provided. The wheel has a flywheel rotatable about a flywheel rotation axis. A flywheel drive is positioned to engage the flywheel to control rotation thereof. A control unit is coupled to the flywheel drive and configured to determine a target rotation speed for the flywheel based at least partially on user input received via an electronic user interface and motion data received from at least one sensor, and direct the flywheel drive to rotate the flywheel at the target rotation speed.

### CROSS-REFERENCE TO RELATED APPLICATIONS

This application claims the benefit of U.S. Provisional Patent Application No. 62/401,790, filed Sep. 29, 2016, and U.S. Provisional Patent Application No. 62/401,798, filed Sep. 29, 2016, the contents of both of which are incorporated herein by reference in their entirety.

### FIELD

The specification relates generally to vehicles. In particular, the following relates to a wheel for human-operated vehicles, and human-operated vehicles using the same.

### BACKGROUND OF THE DISCLOSURE

Learning to ride a bicycle, or other similar human-operated vehicle, is a challenge faced by young children (and some older ones). Similarly, riding a bicycle can be difficult for disabled persons who require continual assistance in order to maintain stability, or for elderly or other persons who have lost their aptitude for cycling or have a diminished sense of balance.

Prospective riders must develop awareness of what are, in essence, complex Newtonian principles of force-balance, gravity, torque, inertia and momentum. Only by continually adjusting weight and balance for the prevailing velocity and turn radius can one proficiently ride a bicycle for any distance. Starting a bicycle from a standing position is a particular challenge as the forward velocity needed to maintain balance has not yet been established. Likewise, turns are difficult for new riders as the weight and balance of the bicycle and rider shifts suddenly and may become difficult to control. It is not uncommon for new riders to jack-knife the bicycle wheel, causing both bike and rider to tumble over.

The usual time-tested approach to preparing children to ride by exposing them to the basic dynamics of a bicycle is the use of training wheels. Briefly, training wheels are typically a pair of small-diameter, hard rubber/plastic wheels attached by removable brackets to the rear axle. Training wheels, however, are inadequate because they do not simulate real, unrestricted bicycle movement. They incorrectly teach riders to balance by relying on the training wheels rather than actually learning to balance through weight manipulation. Moreover, training wheels inhibit riders from banking as they turn, forcing them into bad habits.

WO2007/005282A2 discloses a stabilizing system and method for two-wheeled vehicles (typically small, human-powered bicycles) that affords the rider no restriction on the full range of movements (banks, leans, etc.) common to bicycles, but that provides greater stability during turns and other manoeuvers so that an unintentional bank or tilt (potentially leading to a fall) is less likely, even at relatively slow speeds and start-up. A rotating mass of predetermined mass-value and radial mass-distribution is provided optionally coaxially with the front axle. The mass is supported on bearings so as to freewheel with respect to the rotation of the front wheel. As such it can be induced to spin significantly faster than the front wheel thereby generating a gyroscopic effect at the front wheel about the axle. This gyroscopic effect influences the steering of the wheel by the rider. Due to precession, the wheel tends to follow any excessive bank by the bicycle, ensuring that the rider can “steer-out-of” an unintentional tilt. Likewise, the gyroscopic effect limits the rider's ability to execute excessive steering, thereby preventing jack-knife movements.

The mass can be mounted on bearings that are themselves mounted over the centre hub of the bicycle wheel. The bicycle wheel is, in turn, mounted conventionally on a threaded axle that is attached to the front fork by opposing nuts. The mass of this embodiment is unpowered, and initially forced in to rotation by action of a helper (adult) as the rider starts the ride. It can be urged to rotate using a variety of permanently attached and/or detachable mechanisms.

Benefits such as stability provided by a rotating mass or “flywheel” contained in either the front or rear bicycle wheel have recently been discovered. The flywheel creates

[symbol]

The accelerometer can be configured to determine at least one of orientation, velocity, and rotation speed of the wheel.

The at least one sensor can comprise an orientation sensor.

The control unit can be configured to determine the target rotation speed relative to a horizontal plane.

The control unit can be configured to re-determine the target rotation speed at least partially based on a previously-set target rotation speed and subsequently received motion data.

The control unit can be configured to communicate the target rotation speed and the motion data via a communications interface. The target rotation speed and the motion data can be communicated to a remote server.

The electronic user can be a network communications interface configured to receive the user input from a mobile computing device.

The electronic user interface can be an electrical circuit coupled to a physical control.

The user input can comprise a user-selected level of stability assistance.

In another aspect, there is provided a wheel for a human-powered vehicle, the wheel having a flywheel comprising a flywheel rotatable about a flywheel rotation axis, a flywheel drive positioned to engage the flywheel to control rotation thereof, and a control unit coupled to the flywheel drive and configured to determine a target rotation speed for the flywheel based at least partially on motion data received from at least one sensor, and direct the flywheel drive to rotate the flywheel at the target rotation speed.

In a further aspect, there is provided a human-powered vehicle comprising a wheel as described above.

In still another embodiment, there is provided a method of controlling a flywheel, comprising receiving user input received via an electronic user interface, receiving motion data from at least one sensor, determining a target rotation speed for the flywheel based at least partially on the received user input and the received motion data, and directing the flywheel drive to rotate the flywheel at the target rotation speed.

The method can further comprise re-determining the target rotation speed at least partially based on a previously-set target rotation speed and subsequently received motion data.

In still yet another aspect, there is provided a method of controlling a flywheel, comprising receiving motion data from at least one sensor, determining a target rotation speed for the flywheel based at least partially on the received motion data, and directing the flywheel drive to rotate the flywheel at the target rotation speed.

The method can further comprise re-determining the target rotation speed at least partially based on a previously-set target rotation speed and subsequently received motion data.

In a still further aspect, there is provided a wheel for a human-powered vehicle, comprising a loudspeaker positioned within a profile of the wheel, and an audio signal unit positioned within the profile of the wheel and coupled to the loudspeaker to generate audio.

The loudspeaker can be releasably coupled to a rim support member extending between an axle of the wheel and a rim portion of the wheel.

The loudspeaker can be positioned within a recess of the rim support structure, the wheel further comprising a cover covering the loudspeaker within the recess, the cover having a user interface coupled to the audio signal unit.

The audio signal unit can have a wireless communications interface for receiving audio control instructions wirelessly.

In another aspect, there is provided a human-powered vehicle comprising a wheel as described above.

### BRIEF DESCRIPTIONS OF THE DRAWINGS

For a better understanding of the embodiments described herein and to show more clearly how they may be carried into effect, reference will now be made, by way of example only, to the accompanying drawings in which:

FIG. 1 is a side view of a bicycle equipped with a front wheel having a stabilizing system therein in accordance with an embodiment;

FIG. 2 is an exploded side view of the front wheel of FIG. 1;

FIG. 3 is a perspective view of one side of the front wheel of FIG. 1 after removal of the inner tube and the tyre;

FIG. 4 is a perspective view of the other side of the front wheel of FIG. 3;

FIG. 5 is a partial section schematic view of the wheel of FIG. 3 along 5-5;

FIG. 6 shows the wheel of FIGS. 2 to 5 with the control unit placed in the electronics compartment;

FIG. 7 shows the electronics compartment cover of FIG. 2 in greater detail;

FIG. 8 is a schematic diagram of various components of the flywheel control system of the wheel of FIG. 2;

FIG. 9 is a flowchart of the method of determining the target rotation speed of the flywheel of FIG. 2;

FIG. 10 is a schematic diagram of various components of the audio system of the vehicle of FIG. 1 and its operating environment; and

FIG. 11 is a schematic diagram of various components of the vehicle sound system.

### DETAILED DESCRIPTION

For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

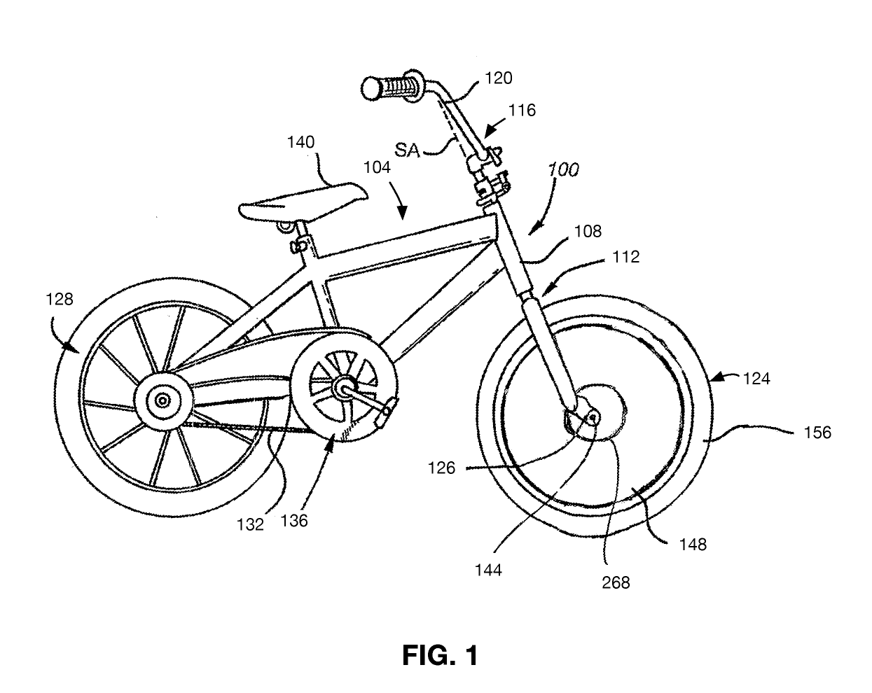

A bicycle 100 having a stabilizing system according to an embodiment is shown in FIG. 1. This bicycle 100 is exemplary of a certain size and style of human-powered two-wheeled vehicle that is particularly adapted for smaller children. The term “bicycle” as used herein is intended to refer to any type of two-wheeled vehicle (including certain powered vehicles) that would benefit from the front-wheel gyroscopic stabilizing effect to be described herein.

The bicycle 100 includes a flywheel inside of the front wheel that can be readily removed and redeployed as desired. Use of the flywheel can assist with balance and turning for a less-experienced rider. There are times, after a user has learned to ride or when a fully trained adult is not in need of the stability offered by the flywheel, when the flywheel's weight is unnecessary and the flywheel's removal will make the entire bicycle lighter and enhance the user's and the bicycle's performance. As used herein, “flywheel” means any rotating mass that is used to resist changes in rotational speed by its moment of inertia. Flywheels can be disk-shaped, or any other suitable design.

The bicycle 100 includes a bicycle frame 104 that typically is constructed from a set of tubular members that are joined together. The tubular members are typically made of a metal, such as steel, aluminum, or titanium, but may also be constructed from other materials, such as carbon fibre, moulded plastic, etc. A head tube 108 of the bicycle frame 104 is open at both ends and rotatably receives a front fork assembly 112 that is coupled to a steering assembly 116. The steering assembly 116 and the front fork assembly 112 are coupled so that turning of the steering assembly 116 about a steering axis SA (that is coaxial with a bore of the head tube 1008) causes the front fork assembly 112 to turn as well. The steering assembly 112 typically includes a pair of handlebars 120 that have grips for a rider to hold. A front wheel 124 is rotatably coupled to fork ends 126 of the front fork assembly 112.

A rear wheel assembly 128 is mounted to the frame 104, and is driven by a chain 132 that is, in turn, operatively connected to a pedal crank assembly 136. A seat 140 is coupled to the bicycle frame 104 at a position to enable a rider to sit on it, operate pedals of the pedal crank assembly 136 with his or her feet, and steer the front wheel 124 by turning the steering assembly 116.

The bicycle 100 stays upright while moving forward by being steered by a rider via the handlebars 120 so as to keep the rider's centre of mass over the wheels. The coordination of pedaling and steering while maintaining one's centre of mass over the wheels takes practice by the rider to achieve. Further, the rider must lean into a turn so that the combined centre of mass of the bicycle 100 and the rider lean into a turn to successfully navigate it. This lean is induced by a method known as counter-steering, which can be performed by the rider turning the handlebars 120 directly with the hands or indirectly by leaning the bicycle 100. A common beginner's error while learning to ride a bicycle is to oversteer; that is, to overturn the front wheel 124 so that the forward momentum of the bicycle acts to pull the bicycle to the outside of the turn, potentially causing the rider and bicycle to lose balance and fall.

“Wobble” or instability means the unstable movement about any one or more of a pitch, roll or yaw axis. The wobble or instability of a rider of a human-powered vehicle such as a bicycle is determined by the position and/or orientation of the wheel relative to one or more the aforementioned axes.

In order to aid a rider in learning to steer the bicycle 100, it is provided with a stabilizing system.

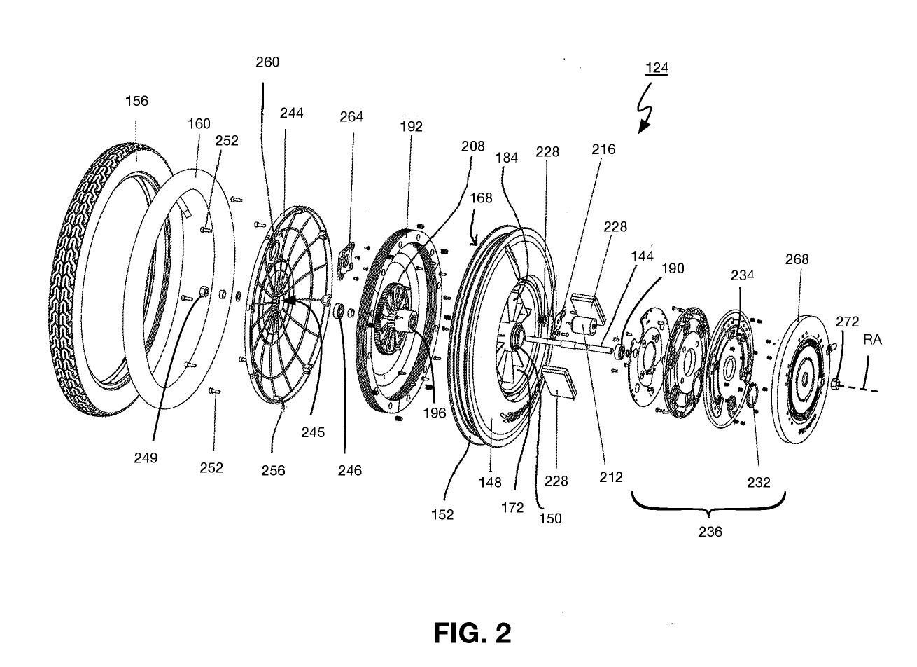

FIG. 2 shows the front wheel 124 exploded along a common lateral axis, the rotation axis RA of the front wheel 124, that is coaxial to an axle 144. The front wheel 124 has a first rim support member 148 having a hub portion 150 that is rotatably mounted on the axle 144. In addition, the first rim support member 148 has a rim portion 152 spaced from its hub portion 150 supporting a tyre 156 and an inner tube 160.

The first rim support member 148 is configured such that it defines at least a part of a flywheel compartment 168 that opens on a first lateral side and an electronics compartment 172 that opens on a second lateral side of the first rim support member 148 opposite the first lateral side. The electronics compartment 172 has an annular shape and is located near and around the hub portion 150 defined by an inner first rim support member portion 176.

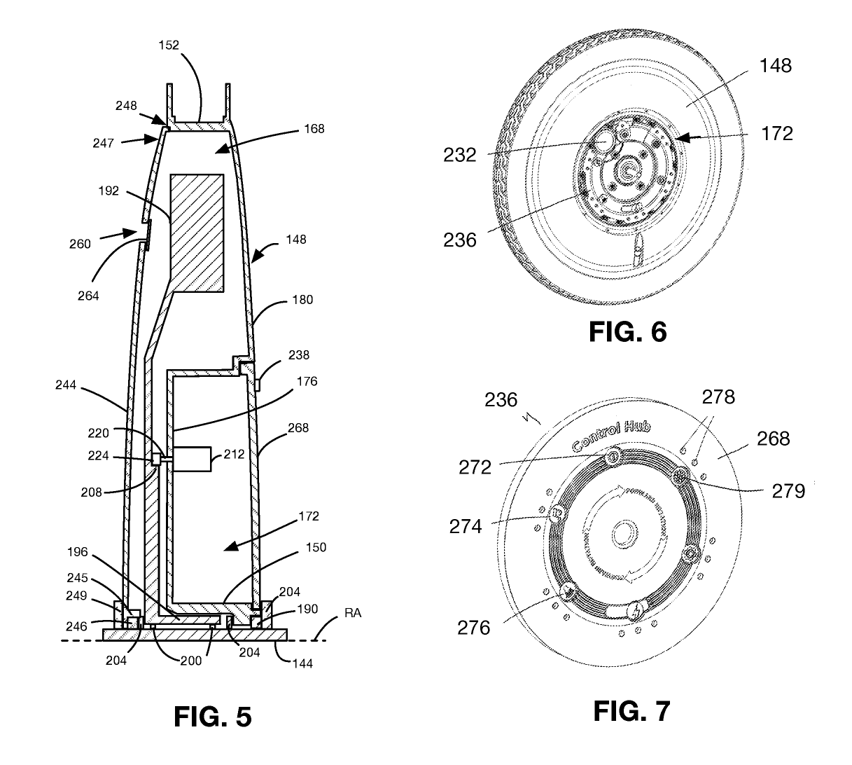

In order to achieve this, the first rim support member 148 has an S-shaped cross-section as shown in FIG. 5.

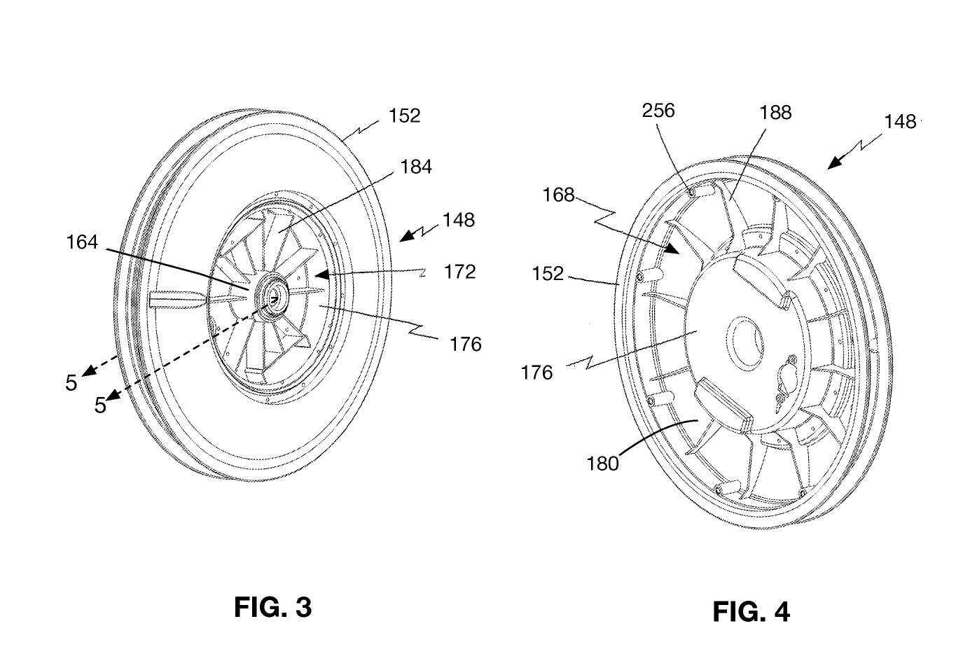

Now referring to FIGS. 1 to 5, ribs 184 extend outwardly radially from the hub portion 150 and along the inner first rim support member portion 176 within the electronics compartment 172. Further, ribs 188 extend outwardly radially from the inner first rim support member portion 176 and along the outer first rim support member portion 180 within the flywheel compartment 168. The ribs 184, 188 are integrally formed with the inner first rim support member portion 176 and the outer first rim support member portion 180. Additionally, the ribs 184, 188 stiffen the first rim support member 148 to counter load forces experienced by the front wheel 124 that act to compress it radially when a rider is riding the bicycle 100. Although integrally formed ribs are used in this embodiment, in other embodiments, the ribs can be secured to the inner first rim support member portion 176 and the outer first rim support member portion 180, or other types of reinforcement, such as thickened portions or the addition of different materials can be employed.

The rim portion 152, outer first rim support member portion 180, the inner first rim support member portion 176, and the hub portion 150 of the first rim support member 148 are integrally formed. In this way, the first rim support member 148 is formed as a single structural element that provides the primary load-bearing element of the front wheel 144. The first rim support member 148 may be formed by moulding or casting, or machining from a single billet on material. In a preferred method of manufacture, the first rim support member 148 is made from polyamide and formed by moulding. It will however be appreciated that any suitable material may be employed, or that the first rim support member 148 can be constructed from multiple elements.

The hub portion 150 of the first rim support member 148 is mounted on a bearing 190 that is, in turn, mounted on the axle 144, allowing the first rim support member 148 to rotate freely about the axle 144.

A removable flywheel 192 that has a hub portion 196 extending from it is positioned in a nested manner next to the first rim support member 148. The hub portion 196 has an outer diameter that fits within a bore of the hub portion 150 of the first rim support member 148. Bearings 200 between the hub portion 196 and the axle 144 enable free rotation of the flywheel 192 relative to the axle 144. Axial shifting of the hub portion 196 along the axle 144 is restricted by clips 204 or some other suitable retaining means, such as nuts.

The flywheel 192 has a toothed annular projection 208 on the surface adjacent the hub portion 196 that has teeth along its circumferential periphery.

The electronics compartment 172 houses flywheel drive and control means. In particular, an electric motor 212 is mounted via a motor mount 216 to the inner first rim support member portion 176 of the first rim support member 148. The electric motor 212 rotatably drives a drive shaft 220 that extends through an aperture in the first rim support member 148 and into the flywheel compartment 168. A flywheel engagement gear 224 is secured on a distal end of the drive shaft 220 within the flywheel compartment 168. The flywheel engagement gear 224 has teeth that correspond to teeth about the toothed annular projection 208 on the flywheel 192, and is positioned to engage and drive the flywheel 192. A pair of batteries 228 provide power to the electric motor 212.

In addition to the electric motor 212 and batteries 228, associated ancillary components such as hardware, circuitry, supervisory electronics and controllers used for the powering and controlling the flywheel 192 in use, as well as an audio loudspeaker 232 by means of which audio instructions from an audio signal generator 234 for the installation and removal process of the flywheel 192 are provided to a user, are housed with the electronics compartment 172. The loudspeaker 232 is preferably water-resistant or water-proof to reduce the probability of accidental water damage. The audio signal generator 234 can be any particular type of device for generating audio signals that the loudspeaker 232 converts into audio, such as music, voice, sounds, etc., and is coupled to storage in which audio signal data is stored. The audio signal generator 234 also is coupled to a wireless communication module, such as a Bluetooth™ module for communicating with other computing devices, such as smartphones, remote controls, and remote servers, for sending and receiving audio signal data and receiving commands for the audio signal generation/playback. Such associated hardware, circuitry and controllers, supervisory electronics and loudspeaker may form part of a module or control unit 236.

In one embodiment, the audio signal generator 234 includes the likes of solid-state accelerometers which can sense the tilt, movement, speed and direction of the wheel 124 and/or bicycle 100, and/or the ability to obtain such inputs from suitable sources, and, based on these inputs, produce and/or record in a memory a synthesized music track that is an interpretation of the actions of the rider which can be played back via the loudspeaker. In another embodiment, orientation sensors are employed.

The audio signal generator 234, the stored audio signal data, and the loudspeaker 232 is referred to as a “vehicle wheel sound system”.

The control unit 236 are powered via the batteries 228, but it can be desirable to provide separate batteries in some embodiments.

The electric motor 212 is actuated via a physical control switch 238 located on a surface of the wheel 124, but may alternatively be actuated by a wired connection to a locking mechanism securing the first cover to the first rim support member, and a wireless connection to the locking mechanism.

A second rim support member 244 has a hub portion 245 that is rotatably mounted on the axle 144 via a bearing 190.

A second rim support member 244 is dimensioned to enclose and seal the flywheel 192 within the flywheel compartment 168 defined by it and the first rim support member 148 to restrict access to the flywheel 192. The flywheel compartment 168 has a dish shape with a thickened periphery, and extends from the axle 144 outwardly radially past the electronics compartment 172 and towards the rim portion 152 as defined by an outer first rim support member portion 180. A hub portion 245 of the second rim support member 244 is releasably rotatably mounted on the axle 144 via a bearing 246. The second rim support member 244 is parabolic in shape and has a circular peripheral lip 247 along its periphery. The circular peripheral lip 247 snugly fits within and abuts a retaining wall 248 along the edge of the rim portion 152. A nut 249 is screwed onto the axle 144 to axially compress the second rim support member 244 against the first rim support member 148. As the second rim support member 244 is compressed, the circular peripheral lip 247 is pushed against the retaining wall 248 to secure the second rim support member 244 relative to the first rim support member 148. The parabolic shape of the second rim support member 244 acts to resist deformation during axial compression. Further, it also allows for additional room within the flywheel compartment 168 defined between the first rim support member 148 and the second rim support member 244.

Although, in this embodiment, a retaining feature in the form of the retaining wall 248 is employed, in other embodiments, other retaining features can be employed. For example, retaining posts projecting from the first rim support member 148 and spaced about its periphery adjacent the rim portion 152 can be employed.

In addition, a set of radial and circumferential ribs are formed on an inner surface of the second rim support member 244 to further stiffen it.

The second rim support member 244 is additionally secured to the first rim support member 148 via a set of screws 252 extending through a set of peripheral through-holes 256 in the circumferential periphery of the second rim support member 244. While screws are used to releasably secure the second rim support member 244 to the first rim support member 148, any other suitable means for releasably securing the second rim support member 244 to the first rim support member 148 can be employed, such as bolts, clips, etc. Further, while the second rim support member 244 is secured to the first rim support member 148 via both axial compression forcing the circular peripheral lip 247 against the retaining wall 248 and the screws 252, it will be understood that in other embodiments that either approach alone for securing the second rim support member 244 to the first rim support member 148 may be sufficient.

Conveniently, the second rim support member 244 is provided with a viewing aperture 260 having an at least somewhat transparent insert 264 that enables a user to view the flywheel 192 when the second rim support member 244 is secured to the first rim support member 148. In this way, the user can visually confirm the presence of the flywheel 192, and can determine whether or not the flywheel 192 is rotating. The ability to determine if the flywheel 192 is rotating helps a user to identify whether or not it is safe to remove the second rim support member 244 to expose the flywheel 192. The at least somewhat transparent insert 264 can be opaque or transparent.

An electronics compartment cover 268 is dimensioned to enclose and seal the electric motor and other electronic components, such as the batteries 228, the loudspeaker 232 and the control unit 236 to protect them from the elements and from accidental or malicious damage, as well as protecting people and animals from the electronic components themselves. The electronic disc cover 268 is also parabolic in shape to allow for additional room within the electronics compartment 172 and provide structural strength to the electronics compartment cover 268. In addition, a set of radial and circumferential ribs are formed on an inner surface of the second rim support member 244 (not shown) to further stiffen the electronics compartment cover 268. A central aperture in the electronics compartment cover 268 is dimensioned to enable its fitting over the axle 144.

The electronics compartment cover 268 is releasably secured to the first rim support member 148 via a nut 272 screwed on the axle 144 after its placement thereon. Contact around the peripheral edge of the electronics compartment cover with the perimeter of the electronics compartment 172 enables the electronics compartment cover 268 to provide structural strength and rigidity generally evenly about its circumference to the first rim support member 148 and thus the wheel 124. While, in this embodiment, the electronics compartment cover 268 is secured to the first rim support member 148 via a nut 272 mounted on the axle 144, any other suitable means for releasably securing the electronics compartment cover 268 to the first rim support member 148 can be employed, such as screws, bolts, clips, etc.

The wheel assembly 124 allows the flywheel 192 to be removed and replaced without exposing the electronic components housed in the electronics compartment 172 of the wheel assembly 124, thereby protecting both the electronic components and the person removing the flywheel 192.

In order to remove the flywheel 192 from the wheel 124, the nut 249 is loosened and removed from the axle 144, and the screws 256 securing the second rim support member 244 to the first rim support member 148 are removed. The removal of the nut 249 and the screws 256 allows the second rim support member 244 to be separated from the first rim support member 148. The bearing 246 is then removed from the axle 144. Upon removal of the bearing 246, the flywheel 192 can be withdrawn from the flywheel compartment 168, thereby releasing the flywheel 192 from the gear 224 coupled to the motor 212. Upon withdrawal of the flywheel 192, the bearing 246 can be repositioned over the axle 144. The second rim support member 244 can then be placed over the bearing 246 and re-secured to the first rim support member 148 to re-close the flywheel compartment 168. The nut 249 is refitted on the axle 144 and provide structural rigidity to the wheel 124 and to secure the second rim support member 244 about its periphery to the first rim support member 148.

The process of re-deploying the flywheel 192 within the wheel assembly 124 follows similar steps, except that the flywheel 192 is re-fitted back atop of the bearings 200.

The wheel 124 and the bicycle 100 can thus be readily adapted to have the flywheel 192 installed or removed. This modular arrangement enables the flywheel 192 to be removed by removing a portion of the rim support without the need to remove the tyre 156. Further, the structure of the wheel 124 enables this to be performed without exposure of and to the electronic elements of the wheel assembly 124.

The first rim support member 148 and the second rim support member 244 when secured in place provide a stable wheel structure for supporting the tyre 156 atop of the axle 144. The securing of the second rim support member 244 to the first rim support member 148 along their periphery and their coupling to the axle 144 with limited axial movement therealong enables the flywheel compartment 168 to be sealed to prevent contact by a person or other objects with the flywheel 192.

Similarly, the batteries 228 can be replaced or the motor 212 and other electronic components such as the control unit 236 can be serviced by unfastening the nut 272 from the axle 144, and then removing the electronics compartment cover 268.

FIG. 6 shows the wheel 124 with the electronics compartment cover 268 removed. As can be seen, the control unit 236 is positioned inside the electronics compartment 172. The control unit 236 includes a central processing unit (“CPU”) and memory (not shown) adapted to intelligently provide outputs to govern the stability provided by the flywheel 192 and its associated stabilizing gyroscopic forces. The control unit 236 also includes additional components such as solid-state accelerometers that can sense the tilt, movement, speed and direction of the wheel 124 and/or bicycle 100, and/or the ability to obtain such inputs from suitable sources.

FIG. 7 shows the electronics compartment cover 268 in greater detail. Exemplary button 278 on the electronics compartment cover 268 provides an input means by which a user may activate operation of the motor 212 to drive the flywheel 192 to provide gyroscopic stabilisation to the wheel 124. The loudspeaker is governed by an on/off switch (e.g., button 272 on the electronics compartment cover 268 of the control unit 236) and may not always be used by the user of the vehicle to which the wheel is mounted. Selection 274 and volume control 276 buttons are also provided in association with loudspeaker 232.

While a CPU and memory are included, they may not always be needed by a rider of the bicycle 100 as the flywheel 192 may be operated in a “fallback” mode utilizing a simple one or multiple speed interface in the case the CPU and memory are failing or are simply not desired. The CPU and memory comprise a system that receives inputs from a range of signal generators including but not limited to accelerometers, strain gauges, thermometers and other signal generators and that performs calculations to make assessments and its produces outputs to govern (i.e., keep the same or change) the rotational speed of the flywheel 192. It will be appreciated that while the CPU and memory comprising this intelligent control system are described in the present embodiment as being included within control unit 236 that is provided mounted within the electronics compartment 172 of the wheel 124, it is possible that the CPU and memory may be housed outside or remote from the wheel 124.

The CPU and machine executable instructions that the CPU executes for the purpose of determining an appropriate speed of rotation of the flywheel 192 based on monitored inputs and user input may be updated by a connection that is wired, wireless or otherwise, to a device, devices, networks or the Internet, for reloading and or upgrading.

The CPU and its memory may access or may be accessed via a connection, wired, wireless or otherwise, to a device, devices, networks or the Internet, for obtaining data, transmitting data, or for the purposes of interoperating with other devices including but not limited to other computing, servicing and problem determination in nature.

The CPU, its associated programming or algorithms, its memory and associated features may be activated by a range of devices from wired and wireless purpose built controllers and remote controllers to applications resident on smartphones, tablet computers and laptops for the purposes of routine operation or operation in a controlled environment such as but not limited to physical therapy settings, occupational therapy settings and disability training settings.

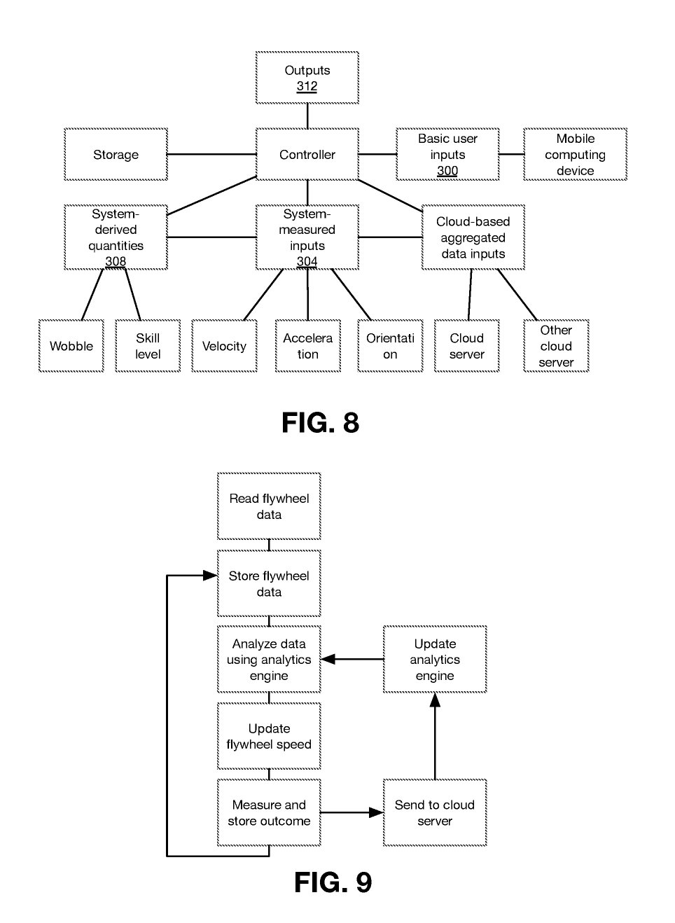

FIG. 8 shows a schematic view of the flow of data within the system. As shown, the range of basic user inputs 300 include but are not limited to user settings for “support level selection”, “riding environment selection”, rider height, weight, etc. The stabilization assistance level corresponds to how active the system is in maintaining the balance of the bicycle 100 and its rider. The stabilization support level can vary from deactivation of the stabilization assistance to full activation of the flywheel 192 to stabilize the rider. The user can select the desired level of stabilization assistance via a physical control, such as a dial, on the electronics compartment cover 268, via an application executing on a mobile computing device such as a smartphone, etc. The control unit 236 can receive the user input via an electronic user interface coupled to the dial and to a wireless network adapter. Alternatively, a touch screen may be provided to enable the user to provide input as to how the user desires for the system to operate.

The range of system measured inputs 304 include, but are not limited to, the following motion data: bicycle velocity, bicycle accelerations in or about up to six axes, and wheel orientation. System derived or calculated amounts 308 include but are not limited to wobble and skill level. The main output 312 is to control the flywheel drive (i.e., the motor 212 that drives the gear 220) that drives rotation of the flywheel 192 but other outputs include, but are not limited to, lighting warning lights, emitting sounds via a loudspeaker, and sending a request for assistance to a known person or entity or an unknown entity such as a safety or policing authority.

Referring now to FIG. 9, there is shown the closed loop nature of the flywheel control system in accordance with an embodiment. In this way, data pertaining to the flywheel status, such as the motion data, is collected and stored continuously for instantaneous analysis after every instruction to change the target flywheel speed is given based on how the motion data indicates that the rider and bicycle are reacting to the previously-set target flywheel speed, and that data is then assessed for its performance in producing the desired outcome of in terms of the right stability for the user as measured by accelerometers in six axes. The ability to provide optimized control over time based on recorded data.

It can be desirable to direct the flywheel drive to rotate the flywheel at the target rotation speed only after the motion data is received over an initial assessment period, and then determine the target rotation speed at least partially by assessing current motion data received relative to the motion metrics received over the initial assessment period. This allows a baseline value to be established.

Also shown is the further step of sending this data and its derived outcomes to a centralized remote facility to aggregate the data and make determinations across multiple users of wheels incorporating the control system.

For example, factors such as rider demographics, flywheel control system settings and the measurement of wobble, can be obtained from multiple users and stored in a remote database to produce a knowledge base for the purpose of improving the delivery of intelligent flywheel control. The ability to collect and collate such data across multiple users can in turn produce benefits not possible without such an intelligent control system for a bicycle having a wheel containing a flywheel.

Machine learning can be employed to process the data and learn how to control the flywheel rotation speed to best stabilize the bicycle 100, and this knowledge can be returned to the control unit 236 to make use of for future target flywheel rotation speed decisions. In this way, higher performing flywheel control programming and algorithms can be provided. Factors such as rider demographics, flywheel control system settings and the measurement of novel concepts such as wobble, individually and in the aggregate across all, most or some users produce a knowledge base that in turn may lead to improvements in the delivery of intelligent flywheel control and therefore may produce benefits not possible without such an intelligent control system for a bicycle having a wheel containing a flywheel.

The modularity of the control unit 236 facilitates its removal or replacement, or deactivation of the control unit 236 where not needed to conserve battery power, change the riding characteristic of the vehicle, etc. The ability of the flywheel control system to accept inputs from a variety of signal generating input devices which can deliver signals in digital or analogue form, and conveying conditional variables which signal generating input devices are purpose built to sense and relay, so that these inputs can be used to refine the control of the speed of a flywheel 192 in an intelligent manner to enable production of improved control outputs.

For the purposes of refining flywheel control systems in the field that a system consistent with methods known to persons practiced in the art can upgrade and therefore improve intelligent flywheel control systems providing the user the option to not upgrade their flywheel control system, to upgrade their flywheel control system, or to select an option that allows them to try both for a period of time allowing the user to selectively alternate between control system versions until making a determination and selection as to which is best suited for their needs.

The installation and removal process can be embodied in any conceivable use of widely available and novel electro-mechanical and electronic means whether controlled by firmware or software, for the purpose of simplicity, convenience and safety. The installation and removal process anticipates but does not require the use of lights and sounds guiding users through the installation and removal process. Audible installation and removal instructions are provided to a user via the loudspeaker 232. The audio loudspeaker 232 is also usable so that other sounds, such as, for example, music, tones, or words of encouragement, can be played for the benefit of a user or bystanders. Preferably, the loudspeaker 232 is waterproof so that operation is unaffected by adverse wet conditions. Also as described previously, the loudspeaker 232 may be provided as part of the control unit 236 that is mountable on the wheel 124 within the electronics compartment 172, and which may also include circuitry, controllers, supervisory electronics for powering and controlling the flywheel in use.

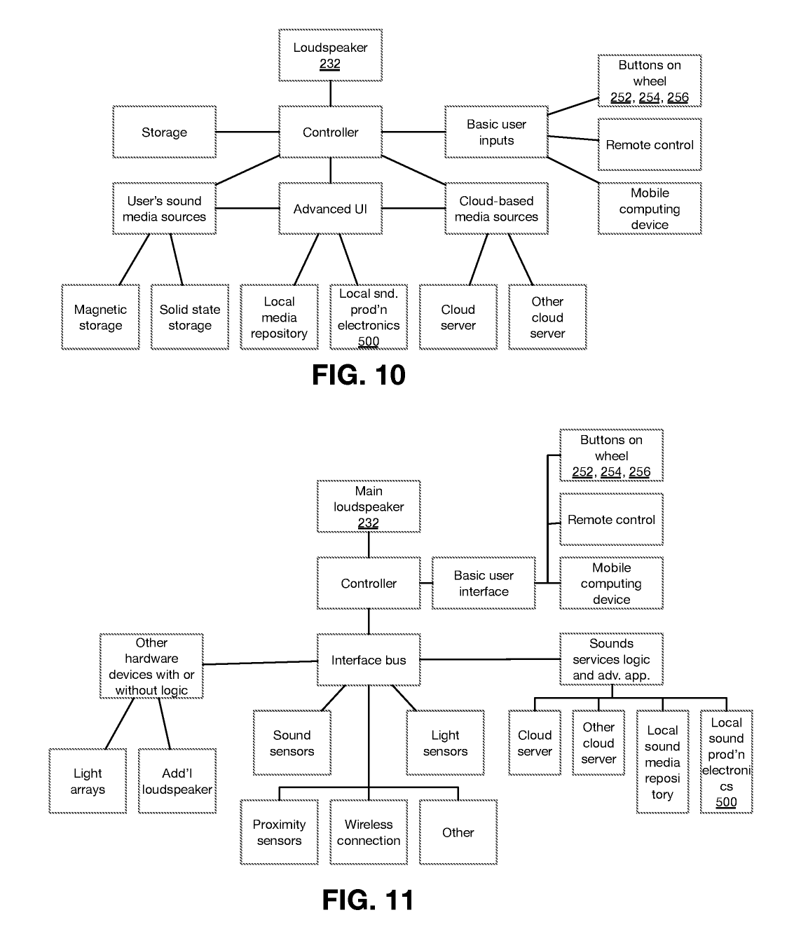

Turning now to FIG. 10, there is shown a schematic diagram of the controlling electronics and control inputs for a system incorporating a loudspeaker provided on a wheel of a human-powered vehicle. Multiple sources of the system can connect to access sound and voice recordings from either local or remote storage. These sources include, but are not limited to a) recordings produced and stored by its own sound production system and supporting electronics, b) recordings accessed on another device through wired or wireless connections, c) recording accessed via a network such as the Internet or other network including but not limited to local area networks via a wired or wireless connection, and d) any other repository of sound or voice recordings on any other media including solid state storage, disk drive or any other electronic media.

The supporting electronics to generate and therefore produce and or reproduce sounds can received inputs from the likes of solid-state accelerometers which can sense the tilt, movement, speed and direction of the wheel and/or vehicle, and/or the ability to obtain such inputs from suitable sources, and based on these inputs produce and/or record in a memory a synthesized music track that is an interpretation of the actions of the rider which can be played back via the loudspeaker. Such inputs are indicated generally by the box 304 labelled “System Measured Inputs” of FIG. 8 as derived from an overall electronic control system of an exemplary wheel.

This ability to produce and/or record synthesized a music track that is an interpretation of the actions of the rider is indicated by way of example in the box 500 labelled “Local Sound Production Electronics” of FIGS. 10 and 11.

Referring again to FIG. 11, there are shown further advantageous optional entertainment items associated with the system by which the loudspeaker operates. These items include, but are not limited to, light arrays on vehicle to which the wheel having a loudspeaker is fitted, and that work in conjunction with the production of sound, as well as but not limited to the involvement of devices separate from vehicle that interact with the production of sound by the vehicle's loudspeaker and supporting system through either a) sound waves, b) light interaction, c) proximity sensing, d) wireless connection or e) any other method commonly found in the art that would allow interaction between the two wheel vehicle, the wheel based sound system and additional devices.

The provision of a loudspeaker in a wheel of a human-powered vehicle, such as a bicycle, can be for any purpose, with the most likely purpose being that to provide information and enjoyment by generated sound equivalent to spoken words (voice), music, song, or any sound, naturally occurring, recorded and reproduced or man-made, recorded and reproduced.

The loudspeaker and its electronics are involved and integral to a process that allows for the use of many sounds, songs, voice tracks either single tracked or branching based on multi-dimensional criteria from multiple inputs, whether these are installed at the time of manufacturing or they are placed into the system through common methods to placing options into sound systems for the selection of new items by a user of such a sound loudspeaker. This placing of options of new items for selection is anticipated to happen a number of times without limitation.

The placing of options process can be embodied in any conceivable use of widely available and novel mechanisms for the purposes of simplicity, convenience and access including but not limited to access to a server containing such option and, in general, the Internet. The installation and removal process specifically anticipates the use of wired connectivity as well as but not limited to wireless connectivity to smartphones, computers, computer networks and the Internet.

The placing of options process can be embodied in any conceivable use of widely available and novel electronic methods, whether controlled by firmware or software, for the purpose of simplicity, convenience and access. The placing of options process anticipates but does not require the use of lights (e.g. lights 278 in FIG. 7) and sounds guiding users through the placing of options process including but not limited to “Download Commencing” and “Download Complete” accompanied by a sequence of flashing lights to indicate successful completion.

The loudspeaker 232 can be removed from the wheel 124. This can be advantageous where, for example, the wheel 124 and/or bicycle 100 is sold without the loudspeaker 232 deployed thereon, and the loudspeaker 232 can be sold thereafter, together with other components, as an add-on.

That, for the purposes of playing options for the use of the sound system that such activation may occur directly through the use of a button switch or the use of a programmable button switch or the use of a handheld remote control or the use of a handlebar mounted wired or wireless control or the use of a device utilizing the Bluetooth or Bluetooth Smart wireless system.

Still further, the audio signal generator 234 can be triggered by sound, a detected pattern of movement, a speed to congratulate the rider, a maximum speed to alert the rider, etc.

That, for the purpose of providing additional options the sound loudspeaker and its system can connect to other systems directly or indirectly to access additional playing options for the benefit of the user.

The skilled man can see that the wheel and the support cover may have any suitable size, shape, design and dimensions, generally able to provide support for and at least some covering on each side of the flywheel. The shape, size or design of the wheel and the support cover.

The support cover shape and dimensions can be varied. It is desirable in most embodiments that the support cover is secured to the first rim support member close to its periphery, preserving sufficient room in the flywheel compartment for the flywheel to rotate unimpeded. For example, the support cover may be any one of a number of polygonal shapes, starfish shaped, etc.

The support cover and the first rim support member can be partially open to show the rotation of the flywheel in some embodiments. The flywheel may be decorated in a manner that is entertaining when viewed through the opening(s) of the support cover and the first rim support member.

The position of the loudspeaker and other components can be varied within the wheel, as will be understood. Further, in some embodiments, two or more loudspeakers can be deployed on opposite sides of the wheel, such as to provide stereo sound to a rider of the vehicle.

The size, shape, dimensions or design of the first rim support member and the second rim support member can be varied. For example, the first rim support member and the second rim support member can be parabolic, frustoconical, or any other suitable shape.

While, in the above described embodiment(s), the rim portion forms part of the first rim support member, in other embodiments, the rim portion can form part of the second rim support member, can be separately provided, or can be formed by elements of the first rim support member and the second rim support member.

The retaining feature(s) (e.g., the retaining wall in the above-described embodiment) can be provided by the second rim support member, with the first rim support member fitting therein. In this case, it may be preferable to have the rim portion extend from the second rim support member. Further, the retaining feature(s) in other embodiments can be other protruding features, such as posts, or any other suitable feature for the opposing rim support member to be constrained by at least radially.

In a similar manner, the flywheel may have any shape, size or design, generally being symmetric about at least one central axis so as to provide precession.

Also, the location of the flywheel relative to the symmetry of the wheel, in particular the symmetry of the wheel axle. That is, the flywheel may be locatable co-axially with the rotation axis of the wheel, or non-co-axially, whilst still providing the precession effect when the wheel is in motion.

While the location of the flywheel drive motor, the power source, and the other electrical components is within a separate compartment in the above-described embodiment, it will be appreciated that, in other embodiments, one or more of these components can be placed in the same compartment as the flywheel. In still further embodiments, a separate electronics compartment can be omitted.

In another embodiment of the present invention, the fasteners can include one or more security mechanisms to prevent their easy unfastening, and thus any unintentional or accidental unfastening. Such security mechanisms may include the shape, size, design and/or pattern of the fasteners, such as bolts having special security engagements such as distinct shaped heads or slots, depressions etc., or one or more locking mechanisms preventing unfastening of the fasteners without unlocking the locking mechanism. Such locking mechanisms may be physical, electronic, or both, and may include one or more alarms indicating the unlocking or preparation for unlocking of the fasteners, and/or one or more safety plug inserts.

In particular, it is preferred that any such locking mechanism includes an electronic code required to be properly entered to allow separation of the parts of the casing (i.e., the wheel and support cover) in a safe manner prior to removal of the flywheel. Such locking mechanisms may be activated by one or more devices located on the wheel, or via a wired or wireless connection to said locking mechanisms.

The mounting orientation of the flywheel is made certain by a system of marks, seats and notches. The mass may be fixed in the wheel and therefore rotate with the wheel or it may be mounted to an assembly that allows the mass to spin independently of the bicycle wheel.

For the purpose of orientating the mass, a system of seatings, marks and optionally notches of any number or shape can be implemented to orient the flywheel should flywheel orientation provide any benefit.

For the purpose of making the removal process of the movable mass depend on the availability of a special purpose tool, the removal process may utilize fasteners of a type that require a special purpose tool such as screws with unique screw slottings. In this way, the unauthorized access to the flywheel within the wheel is mitigated.

For the purpose of providing additional capability supporting the installation and removal process, the process may involve electro-mechanical devices like solenoid actuators and/or electronics that, with the installation or removal process underway, change the operation of the wheel so that normal operation is not possible (e.g., rotation of flywheel cannot be activated during the installation and removal process).

In some embodiments, it may be desirable to only adjust the rotation speed of the flywheel in response to motion data captured via sensors. In this manner, the wheel can be simpler to employ.

It will be appreciated that, while the flywheel is mounted co-axially with the axle of the wheel in the above embodiment, it may be mounted at a position that off-axis with respect to the axle. In either case, the flywheel maintains its ability to create a gyroscopic effect to influence the steering of the wheel by the rider.

While, in the above described and illustrated embodiments, the wheels having the above-described features are deployed on human-powered bicycles, such wheels can be deployed on other types of human-powered vehicles, such as, for example, tricycles and electrically driven bicycles.

Persons skilled in the art will appreciate that there are yet more alternative implementations and modifications possible, and that the above examples are only illustrations of one or more implementations. The scope, therefore, is only to be limited by the claims appended hereto.

1. A wheel for a human-powered vehicle, comprising:
a flywheel rotatable about a flywheel rotation axis;
a flywheel drive positioned to engage the flywheel to control rotation thereof; and
a control unit coupled to the flywheel drive and configured to determine a target rotation speed for the flywheel based at least partially on user input received via an electronic user interface and motion data received from at least one sensor, and direct the flywheel drive to rotate the flywheel at the target rotation speed.

2. A wheel according to claim 1, wherein the control unit is configured to direct the flywheel drive to rotate the flywheel at the target rotation speed only after the motion data is received over an initial assessment period.

3. A wheel according to claim 2, wherein the control unit is configured to determine the target rotation speed at least partially by assessing current motion data received relative to the motion metrics received over the initial assessment period.

4. A wheel according to claim 1, wherein the at least one sensor comprises an accelerometer.

5. A wheel according to claim 4, wherein the accelerometer is configured to determine at least one of orientation, velocity, and rotation speed of the wheel.

6. A wheel according to claim 1, wherein the at least one sensor comprises an orientation sensor.

7. A wheel according to claim 1, wherein the control unit is configured to determine the target rotation speed relative to a horizontal plane.

8. A wheel according to claim 1, wherein the control unit is configured to re-determine the target rotation speed at least partially based on a previously-set target rotation speed and subsequently received motion data.

9. A wheel according to claim 8, wherein the control unit is configured to communicate the target rotation speed and the motion data via a communications interface.

10. A wheel according to claim 9, wherein the target rotation speed and the motion data are communicated to a remote server.

11. A wheel according to claim 1, wherein the electronic user interface is a network communications interface configured to receive the user input from a mobile computing device.

12. A wheel according to claim 1, wherein the electronic user interface is an electrical circuit coupled to a physical control.

13. A wheel according to claim 1, wherein the user input comprises a user-selected level of stability assistance.

14. A wheel for a human-powered vehicle, the wheel having a flywheel comprising:
a flywheel rotatable about a flywheel rotation axis;
a flywheel drive positioned to engage the flywheel to control rotation thereof; and
a control unit coupled to the flywheel drive and configured to determine a target rotation speed for the flywheel based at least partially on motion data received from at least one sensor, and direct the flywheel drive to rotate the flywheel at the target rotation speed.

15. A human-powered vehicle comprising a wheel according to claim 1.

16. A method of controlling a flywheel, comprising:
receiving user input received via an electronic user interface;
receiving motion data from at least one sensor;
determining a target rotation speed for the flywheel based at least partially on the received user input and the received motion data; and
directing the flywheel drive to rotate the flywheel at the target rotation speed.

17. A method according to claim 16, further comprising:
re-determining the target rotation speed at least partially based on a previously-set target rotation speed and subsequently received motion data.

18-24. (canceled)
